(19) United States
(12) Patent Application Publication
(10) Pub. No.: US 2009/0162615 A1
(43) Pub. Date: Jun. 25, 2009

(54) METHOD FOR MANUFACTURING PLASMA DISPLAY PANEL AND PLASMA DISPLAY PANEL

(75) Inventors: Hiroshi Miyashita, Miyazaki (JP); Koji Ohira, Miyazaki (JP)

Correspondence Address: MILES & STOCKBRIDGE PC, 1751 PINNACLE DRIVE, SUITE 500, MCLEAN, VA, 22102-3833, US

(73) Assignee: HITACHI, LTD.

(21) Appl. No.: 12/187,445

(22) Filed: Aug. 7, 2008

(30) Foreign Application Priority Data
Dec. 19, 2007 (JP) 2007-326745

(51) Int. Cl. B32B 3/30; B32B 37/00

(52) U.S. Cl. 428/167; 156/87

(57) ABSTRACT

A plasma display panel (PDP) having a front substrate structure (first substrate structure) and a back substrate structure (second substrate structure) arranged so as to be opposed to each other via a discharge space is manufactured in the following manner. A sealing member arranged in a frame shape so as to surround outside of a barrier rib formation region where barrier ribs partitioning a discharge space are arranged and a plurality of supporting members arranged in a region between an outer periphery of the barrier rib formation region and the sealing member are formed, respectively. The supporting members are made from material having a softening point higher than that of material for the sealing member, the height of the supporting members is made higher than that of the barrier ribs, and the height of the sealing member is made higher than the height of the supporting members.

### CROSS-REFERENCE TO RELATED APPLICATION

The present application claims priority from Japanese Patent Application No. JP 2007-326745 filed on Dec. 19, 2007, the content of which is hereby incorporated by reference into this application.

### BACKGROUND OF THE INVENTION

The present invention relates to a technique of a plasma display panel having a front substrate structure and a back substrate structure, the plasma display panel (PDP) which is a device for display generally includes a front substrate structure and a back substrate structure arranged so as to be opposed to each other via a discharge space and has a structure where mixed gas such as, for example, rare gas called “discharge gas” is filled in the discharge space. The discharge space is partitioned by stripe-shaped or grid-shaped barrier ribs formed on the back substrate structure.

Phosphors emitting visible lights of red (R), green (G), and blue (B) excited by ultraviolet rays emitted from predetermined discharge gas by discharging are formed on side faces of the barrier ribs and a bottom of the discharge space, and the visible lights pass through the front substrate structure to form a desired image on a surface side.

A step of filling discharge gas in a discharge space of a PDP is performed in the following manner.

As a sealing step, first, an outer periphery of the PDP is sealed by a sealing member comprising low melting point glass or the like provided on an outer periphery of a front substrate structure or a back substrate structure.

Next, as an exhausting step, gas contained in a space (including a discharge space) sealed by the front substrate structure, a back glass substrate, and a sealing member is exhausted up to a predetermined vacuum degree via an air-flow hole formed inside of the sealing member.

Next, as a discharge gas filling step, filling of discharge gas required for discharging is performed with a predetermined gas pressure and a gas-flow passage for gas connected to the air-flow hole is then completely sealed.

Here, when exhausting at the exhausting step is insufficient, organic-system impurity gas may remain in the discharge space. At the discharge gas filling step, such a case may occur that impurity gas such as CO₂ or H₂O enters into the discharge space together with the discharge gas. When the impurity gas is adsorbed on a barrier rib or a phosphor in a display region (a discharge space for forming a desired image) or a protective film formed on a surface of the front substrate structure on the discharge space side, such a problem arises that a difference in voltage characteristic occurs, which results in deterioration of display quality.

Some methods have been proposed which prevent adsorption of the impurity gas within a display region.

For example, Japanese Patent Application Laid-Open Publication No. 2006-310050 (Patent Document 1) discloses a structure where a discharge gas introducing passage is formed near a gas-flow hole and impurity gas is caused to be adsorbed on a protection film in the introducing passage so that the impurity gas is suppressed from reaching the display region.

For example, Japanese Patent Application Laid-Open Publication No. 2002-056780 (Patent Document 2) discloses a structure where an exhausting barrier wall is formed inside a sealing member and a gas-flow hole is formed between the sealing member and the exhausting barrier wall so that exhausting conductance at the above-mentioned step (b) is made even.

### SUMMARY OF THE INVENTION

However, there are following problems which cannot be solved by the techniques disclosed in the above-mentioned Patent Documents 1 and 2.

At the sealing step and the exhausting step, first, a paste-like sealing member is applied to an outer periphery of the front substrate structure or the back substrate structure in a quadrangular frame shape. Next, the front substrate structure and the back substrate structure are disposed so as to face each other in an aligned state thereof and they are fixed by a metal clip or the like.

In such a state, gradual temperature rising is performed and when a temperature reaches a temperature where the sealing member melts, exhausting is started. Ideally, such a situation may be preferable that the temperature of the whole PDP rises according to the same temperature profile, and the sealing member at four sides simultaneously melts so that the four sides of the front substrate structure (or the back substrate structure) simultaneously sink down.

However, it is difficult to raise the temperature of the whole PDP according to the same temperature profile and variations in temperature are caused so that such a situation may occur that only one side of the front substrate structure (or the back substrate structure) sinks down in first. In this case, variations may occur in an exhausting state in a space sealed by the front substrate structure, the back substrate structure and the sealing member.

Even if the sealing member at the four sides are simultaneously melted, the front substrate structure and top portions of the barrier ribs come in close contact with each other in a short time so that such a case may occur that an exhausting resistance in the exhausting passage becomes large and exhausting becomes insufficient within the discharge space. Especially, in a PDP having a structure where barrier ribs are formed in a grid shape, so-called box structure, since the surround of the discharge space is enclosed by the barrier ribs so that the exhausting passage is narrowed, thereby exhausting tends to be insufficient.

Thus, when variations in exhausting state occur or when exhausting becomes insufficient, a possibility that impurity gas remains in the discharge space becomes high. Therefore, in order to exhaust the impurity gas completely, it is necessary to conduct exhausting for a long period of time, which results in lowering of manufacturing efficiency of a PDP.

The above-mentioned Patent Document 1 describes a countermeasure against impurity gas introduced when discharge gas is filled in the discharge space, but it does not describe a countermeasure against impurity gas remaining due to insufficient exhausting. In the technique disclosed in Patent Document 1, since the discharge gas introducing passage is formed to restrict the air-flow passage inside the PDP in one direction, an exhausting efficiency may lower due to static pressure.

The above-mentioned Patent Document 2 describes that the exhausting conductance is made even by providing the exhausting barrier wall. However, in a structure where an air-flow hole is simply provided between the sealing member and the exhausting barrier wall, the exhausting conductance inside the PDP evenly lowers, which may result in lowering of the exhausting efficiency.

In view of these circumstances, the present invention has been made and an object thereof is to provide a technique which can reduce an impurity concentration within a discharge space of a PDP efficiently.

The above and other objects and a novel feature of the present invention will be apparent from the description of the specification and the accompanying drawings.

A representative one of inventions disclosed in the present application will be briefly explained below.

That is, a method for manufacturing a plasma display panel according to an embodiment of the present invention includes the following steps:

(a) a step of preparing a first substrate structure formed with a plurality of first electrodes and a plurality of second electrodes configuring display electrode pairs on a first side of a first substrate and a dielectric layer covering the display electrode pairs, and a second substrate structure formed with a barrier rib partitioning a discharge space on a second side of a second substrate;

(b) a step of forming a sealing member disposed on the first substrate structure or the second substrate structure in a frame shape so as to surround an outside of a barrier rib formation region where the barrier rib is disposed and a plurality of supporting members disposed in a region between an outer periphery of the barrier rib forming region and the sealing member so as to be spaced from one another, respectively;

(c) a step of disposing the first substrate structure and the second substrate structure so as to be opposed to each other via the discharge space to assemble the first substrate structure and the second substrate structure; The step (c) includes the following steps:

(c1) a step of disposing the first substrate structure and the second substrate structure so as to be opposed to each other via the discharge space;

(c2) a step of sealing an outer periphery of a region where the first substrate structure and the second substrate structure overlap with each other by heating the sealing member and exhausting gas in a space inside the region where the sealing member is formed via an air-flow passage formed between the supporting member and the sealing member.

Here, the supporting members are made from material having a softening point higher than that of the sealing member, and at the step (b), the height of the supporting members is formed to be higher than the height of barrier ribs and the height of the sealing member is formed to be higher than the height of the supporting member.

The typical ones of the inventions disclosed in this application will be briefly described as follows.

That is, according to an embodiment of the present invention, an impurity concentration within the discharge space can be reduced efficiently.

### BRIEF DESCRIPTIONS OF THE DRAWINGS

These and other features, objects and advantages of the present invention will become more apparent from the following description when taken in conjunction with accompanying drawings wherein:

FIG. 1 is a main portion enlarged and exploded perspective view showing a main portion of a PDP according to an embodiment of the present invention in an enlarged manner;

FIG. 2 is a plan view showing a state where a front substrate structure and a back substrate structure shown in FIG. 1 have been stacked to each other;

FIG. 3 is a main portion plan view showing a state where a first substrate structure shown in FIG. 2 has been caused to pass through;

FIG. 4 is a main portion enlarged sectional view showing a state where sealing frit paste and supporting member paste have been applied to the back substrate structure;

FIG. 5 is a main portion enlarged sectional view showing a state where the front substrate structure is disposed to be opposed to the back substrate structure after organic composition compounds contained in the sealing frit paste and the supporting member paste shown in FIG. 4 are evaporated and hardened;

FIG. 6 is a main portion enlarged sectional view showing a state where the sealing member shown in FIG. 5 is softened so that the front substrate structure is supported by the supporting members;

FIG. 7 is a main portion enlarged sectional view showing a state where the temperature of the supporting member shown in FIG. 6 is further raised up so that the supporting members are softened;

FIG. 8 is a main portion enlarged sectional view showing a state where an air-flow tube which is an air-flow passage is sealed after discharge gas has been filled;

FIG. 9 is an explanatory view showing one example of a temperature profile of the front substrate structure and the back substrate structure at the manufacturing steps shown in FIG. 5 to FIG. 8;

FIG. 10 is an explanatory view showing a modified example of the temperature profile shown in FIG. 9;

FIG. 11 is a plan view showing a first modification example of the supporting member shown in FIG. 3;

FIG. 12 is a plan view showing a second modification example of the supporting member shown in FIG. 3; and

FIG. 13 is a plan view showing a third modification example of the supporting member shown in FIG. 3.

### DESCRIPTION OF THE EMBODIMENTS

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof.

Also, components having the same function are denoted by the same reference symbols throughout the drawings for describing the embodiments, and the repetitive description thereof is omitted. In addition, the description of the same or similar portions is not repeated in principle unless particularly required in the following embodiments. Also, in some drawings used in the embodiments, hatching is used even in a plan view so as to make the drawings easy to see.

<Basic Structure of PDP>

Referring to FIG. 1, first, an example of a PDP of an AC surface discharge type will be explained as one example of a structure of a PDP according to the present embodiment. FIG. 1 is a main portion enlarged and exploded perspective view showing a main portion of the PDP according to the present embodiment in an enlarged manner.

In FIG. 1, a PDP 1 includes a front substrate structure (a first substrate structure) 11 and a back substrate structure (a second substrate structure) 12. The front substrate structure 11 and the back substrate structure 12 are stacked to each other in a state where they are arranged so as to be opposed to each other and a discharge space 24 is formed between that. That is, the front substrate structure 11 and the back substrate structure 12 are arranged so as to be opposed to each other via the discharge space 24.

The front substrate structure 11 has a display surface for the PDP 1 and it has a front substrate (a first substrate) 13 mainly made from glass on the side of a display surface thereof. An opposite surface (a first surface) 13a of the front substrate 13 to the display surface is formed with a plurality of X electrodes (a first electrode, a maintenance electrode, a sustain electrode) 14 and a plurality of Y electrodes (a second electrode, a scanning electrode, a scan electrode) 15 which are display electrodes of the PDP 1, respectively.

The X electrode 14 and the Y electrode 15 configure a pair of display electrodes or a display electrode pair for conducting maintenance discharge (display discharge, sustain discharge), and they are alternately arranged so as to extend in a strip-shaped, for example, along a row direction (a first direction, a lateral direction) DX. The pair of X electrode 14 and Y electrode 15 configures a row on display in the PDP 1. Incidentally, in FIG. 1, the pair of X electrode 14 and Y electrode 15 is shown in an enlarged manner, but the PDP 1 includes a plurality of X electrodes 14 and a plurality of Y electrodes 15 corresponding to the number of rows on the display.

The X electrode 14 and the Y electrode 15 comprise an X transparent electrode 14a and a Y transparent electrode 15a made from transparent electrode material such as, for example, ITO (Indium Tin Oxide) or SnO₂, and an X bus electrode (a metal electrode portion) 14b and a Y bus electrode (a metal electrode portion) 15b made from, for example, Ag, Au, Al (aluminum), Cu, Cr, or a laminated body thereof (for example, a laminated body of Cr/Cu/Cr).

In FIG. 1, the X transparent electrode 14a and the Y transparent electrode 15a are shown so as to extend in a strip-shaped, but the shapes thereof are not limited to this strip-shaped. For example, in order to stabilize the sustain discharge and improve the discharge efficiency, such a structure can be adopted that projecting portions are formed so as to extend in directions opposed to each other from positions where the X bus electrode 14b and the Y bus electrode 15b are superimposed such that the shortest distance (called “discharge gap”) between a pair of electrodes approaches a cell correspondingly.

These electrode groups (X electrodes 14, Y electrodes 15) are covered with a dielectric layer 17.

A protective layer 18 is formed on a surface of the dielectric layer 17 in order to protect the dielectric layer 17 from impact due to hit (sputter) of ions or the like occurring at the sustain discharge described above or the like. The protective layer 18 is formed so as to cover one surface of the dielectric layer 17. Since the protective layer 18 is required to have high sputter resistance and secondary electron emission coefficient, it can be made from material mainly including, for example, MgO (magnesium oxide).

On the other hand, the back substrate structure 12 includes a back substrate (a substrate, a second substrate) 19 mainly made from glass. A plurality of address electrodes (third electrodes) 20 is formed on surface (a second surface, an inside surface) of the back substrate 19 opposite to the front substrate structure 11. Each of the address electrodes 20 is formed so as to extend along a column direction (a second direction, a vertical direction) DY intersecting (approximately orthogonal to) a direction in which the X electrode 14 and the Y electrode 15 extend. Each of the address electrodes 20 is arranged at predetermined arrangement intervals so as to be approximately parallel to one another.

Material for configuring the address electrodes 20 can be used such as, for example, Ag, Au, Al (Aluminum), Cu, Cr, or a laminated body thereof (for example, a laminated body of Cr/Cu/Cr).

The address electrode 20 and the Y electrode 15 formed on the front substrate structure 11 configure an electrode pair for performing address discharge which is discharge for selecting lighting/non-lighting of a cell 25. That is, the Y electrode 15 has both a function as an electrode for sustain discharge and a function as an electrode for address discharge (scanning electrode).

The address electrodes 20 are covered with a dielectric layer 21. A plurality of barrier ribs (first barrier ribs) 22 extending in a thickness direction of the back substrate structure 12 is formed on the dielectric layer 21. The barrier ribs 22 are formed so as to extend in a line shape along the column direction DY in which the address electrodes 20 extend. A position of the barrier rib 22 on plan is arranged between adjacent address electrodes 20. By positioning each barrier rib 22 between the adjacent address electrodes 20, discharge spaces 24 sectioning a surface of the dielectric layer 21 in the column direction DY are formed corresponding to positions of the respective address electrodes.

Gas such as rare gas called “discharge gas” is filled in the respective discharge spaces 24 with a predetermined pressure. As the discharge gas, mixed gas such as, for example, Xe—Ne—He where a partial pressure rate of Xe has been adjusted to several percentages to several tens percentages is used, where a pressure of gas to be filled can be set to, for example, 400 torr to 600 torr (about 54 kPa to about 80 kPa).

FIG. 1 shows an example where the barrier ribs 22 are formed in a stripe shape along the column direction DY, but arrangement of the barrier ribs 22 is not limited thereto. For example, such a configuration can be adopted that second barrier ribs extending in the row direction DX are arranged in addition to the barrier ribs 22 extending along the column direction DY so that the discharge space 24 is partitioned in a grid shape. In this case, since the discharge space 24 is partitioned in a box shape corresponding to each cell 25 by the barrier ribs 22 and the second barrier ribs, such a structure of the barrier ribs is called “box structure”.

Phosphors 23r, 23g, and 23b excited by vacuum ultraviolet rays to emit visible lights having respective colors of red (R), green (G) and blue (B) are formed at predetermined positions on upper faces of the dielectric layer 21 on the address electrodes 20 and side faces of the barrier ribs 22.

The front substrate structure 11 and the back substrate structure 12 are fixed so as to be opposed to each other in a state where a surface of the front substrate structure 11 on which the protective layer 18 has been formed and a surface of the back substrate structure 12 on which the barrier ribs 22 have been formed are opposed to each other.

A cell 25 is configured corresponding to an intersection of a pair of X electrode 14 and Y electrode 15, and an address electrode 20. That is, the cell 25 is formed at each intersection of the display electrode pair (a pair of X electrode 14 and Y electrode 15) and the address electrode 20. A plane area of the cell 25 is defined by an arrangement distance between a pair of X electrode 14 and Y electrode 15 and an arrangement distance of the barrier ribs 22.

Anyone of the phosphor 23r for red, the phosphor 23g for green, or the phosphor 23b for blue is formed at each cell 25.

A pixel is configured by a set of respective cells 25 of R, G, and B. That is, the respective phosphors 23r, 23g, and 23b are light emitting elements which are excited by vacuum ultraviolet rays with predetermined wavelengths generated by sustain discharge to emit visible lights having respective colors of red (R), green (G), and blue (B).

The PDP 1 has a structure where sustain discharge is generated for each cells 25 and the respective phosphors 23r, 23g, and 23b are excited to emit lights by vacuum ultraviolet rays generated by the sustain discharge.

<Structure of Outer Periphery Portion of PDP>

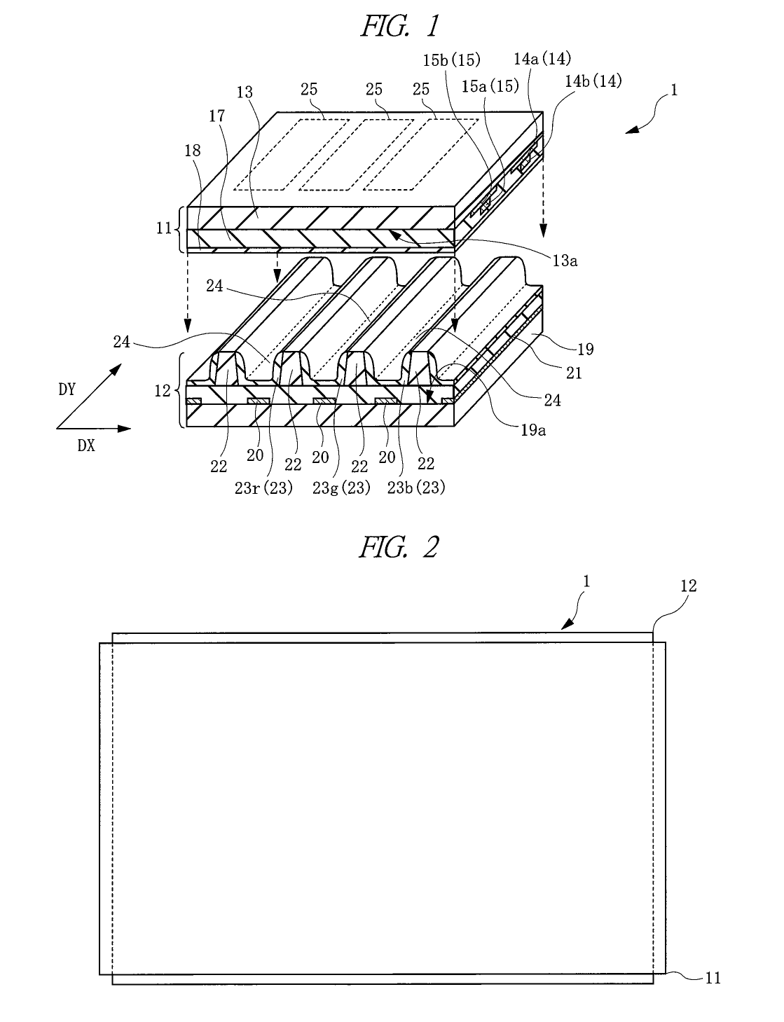

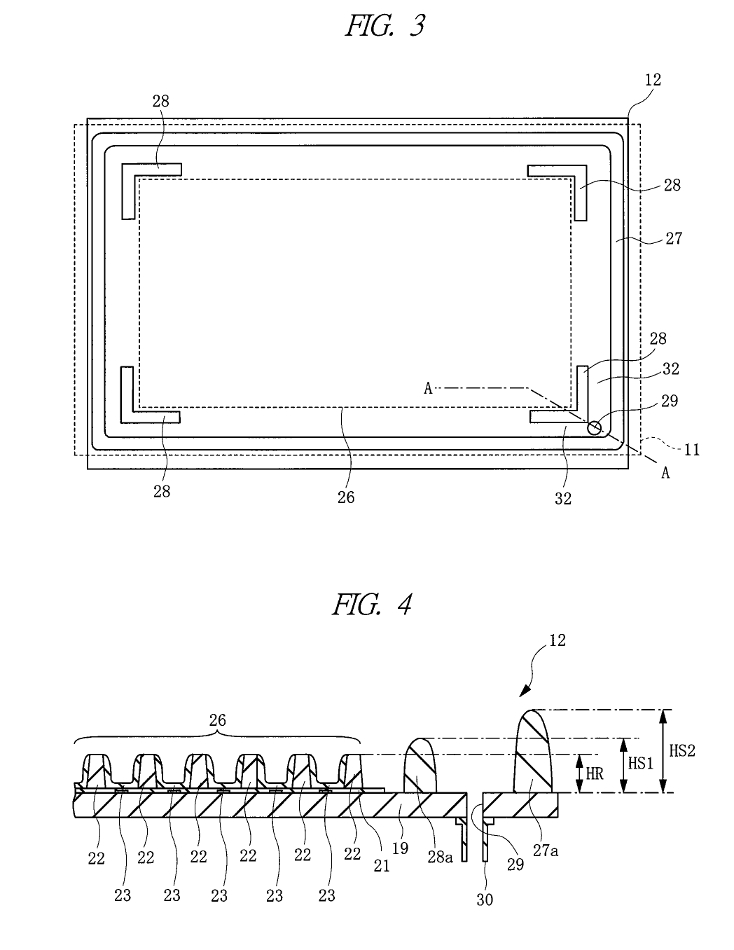

Next, a structure of a surrounding portion of the PDP 1 will be explained with reference to FIG. 2 and FIG. 3.

FIG. 2 is a plan view showing a state where the front substrate structure and the back substrate structure shown in FIG. 1 have been stacked to each other, and FIG. 3 is a main portion plan view showing a state where the first substrate structure shown in FIG. 2 has been caused to pass through. Incidentally, in FIG. 3, illustration of the barrier ribs and the phosphors shown in FIG. 1 is omitted for easy understanding of a positional relationship between a sealing member and supporting members.

As shown in FIG. 2, the PDP 1 has the front substrate structure 11 and the back substrate structure 12 stacked so as to be opposed to each other and it takes an approximately quadrangular (rectangular) shape in plan form.

However, the front substrate structure 11 and the back substrate structure 12 configuring the PDP 1 are different in length of outer edge sides so that they are stacked such that their portions project from each other. This is because electrode terminals of respective electrode groups of the address electrodes 20 (see FIG. 1), the X electrodes 14 (see FIG. 1), and the Y electrodes 15 (see FIG. 1) are formed on the projecting portions for easy electric connection with respective circuits to be connected to the PDP 1.

As shown in FIG. 3, a barrier rib formation region 26 is provided on a central portion of the back substrate structure 12. A plurality of barrier ribs 22 shown in FIG. 1 is formed corresponding to the number of pixels of the PDP 1 in the barrier rib formation region 26. A sealing member 27 is formed outside the barrier rib formation region 26 so as to surround that.

The sealing member 27 is disposed along and outside an outer periphery of a region where the front substrate structure 11 (see FIG. 2) and the back substrate structure 12 overlap with each other and it serves to seal a space (side faces of the PDP1) between the front substrate structure 11 and the back substrate structure 12. Therefore, the sealing member 27 is formed in a continuous frame shape around the barrier rib formation region 26 without forming clearance.

The sealing member 27 is disposed to form a quadrangle along an outer periphery of a region where the front substrate structure 11 and the back substrate structure 12 overlap with each other in order to form a large space inside the PDP 1.

In the present embodiment, supporting members 28 are formed in a region between the barrier rib formation region 26 shown in FIG. 3 and the sealing member 27. A plurality of (four in FIG. 3) supporting members 28 is formed at proper intervals, which is different from the sealing member 27 formed continuously without including a clearance.

The supporting member 28 is made from material having a softening point higher than that of the sealing member 27, so that it is made possible to exhaust gas inside the PDP 1 efficiently at the manufacturing step of the PDP 1. The reason will be explained in detail in explanation about the method for manufacturing the PDP 1.

An air-flow hole 29 serving as an air-flow passage between the inside and the outside in a manufacturing stage of the PDP 1 is formed between the supporting member 28 and the sealing member 27. In FIG. 3, an example where one air-flow hole 29 is formed is shown, but a configuration may be adopted that a plurality of air-flow holes 29 are formed. In FIG. 3, an example where the air-flow hole 29 is formed in the back substrate structure 12 is shown, but the air-flow hole 29 can be formed in the front substrate structure 11.

<Manufacturing Method of PDP>

Next, a manufacturing method of the PDP 1 according to the present embodiment will be explained referring to FIGS. 1 to 10.

FIGS. 4 to 8 are explanatory views showing the manufacturing steps of a PDP according to the present embodiment, FIG. 4 is a main portion enlarged sectional view showing a state where sealing frit paste and supporting member paste have been applied to a back substrate structure, and FIG. 5 is a main portion enlarges sectional view showing a state where the front substrate structure is disposed to be opposed to the back substrate structure after organic composition compounds contained in the sealing frit paste and the supporting member paste shown in FIG. 4 are evaporated and hardened.

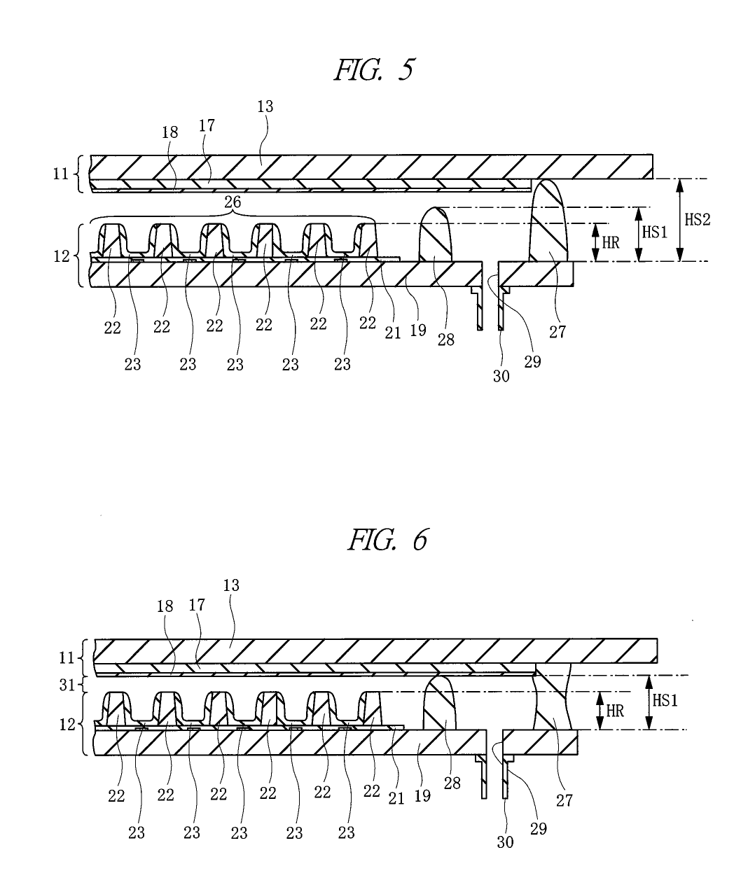

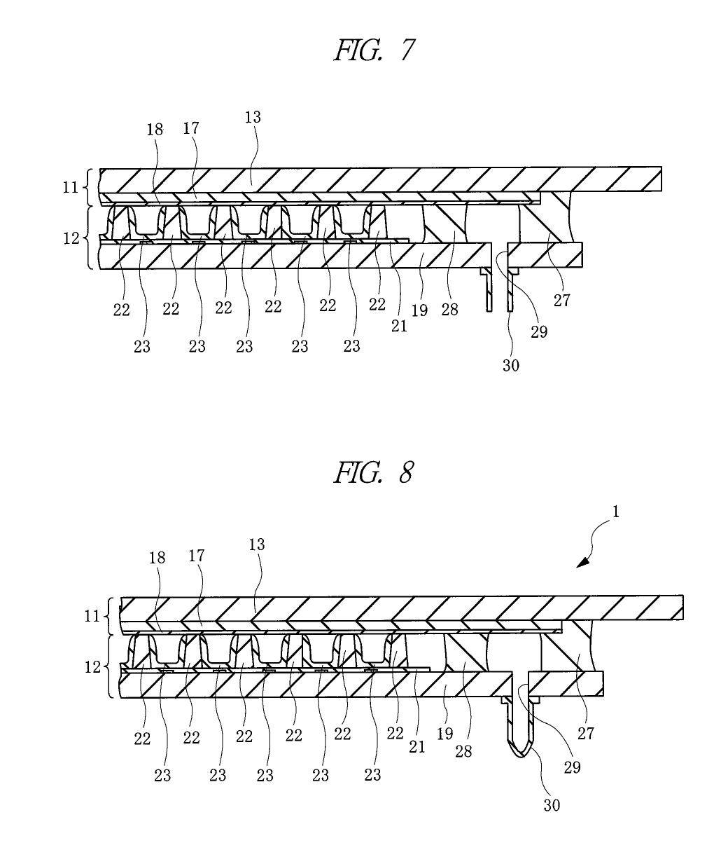

FIG. 6 is a main portion enlarged sectional view showing a state where the sealing member shown in FIG. 5 softens so that the front substrate structure is supported by the supporting members, FIG. 7 is a main portion enlarged sectional view showing a state where the temperature of the supporting members shown in FIG. 6 is further raised so that the supporting members are softened, and FIG. 8 is a main portion enlarged sectional view showing a state where an air-flow tube which is an air-flow passage is sealed after discharge gas has been filled. Incidentally, sections shown in FIGS. 4 to 8 correspond to a section taken along line A-A shown in FIG. 3.

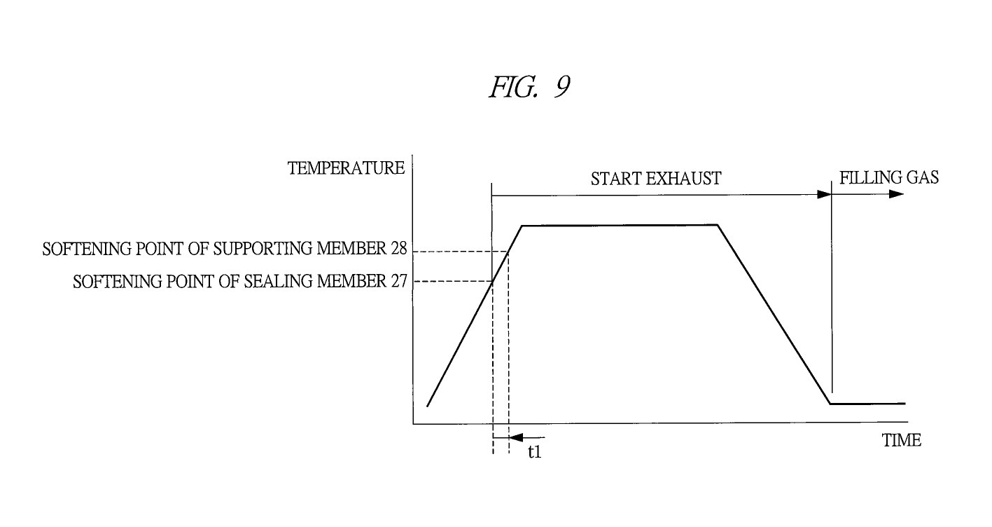

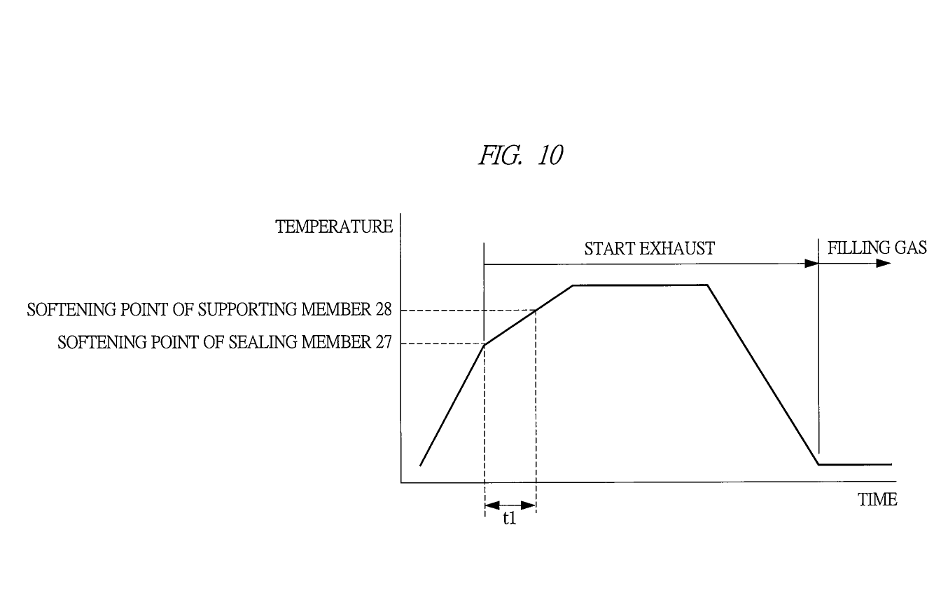

FIG. 9 is an explanatory view showing one example of a temperature profile of the front substrate structure and the back substrate structure in the manufacturing steps shown in FIGS. 5 to 8, and FIG. 10 is an explanatory view showing a modified example of the temperature profile shown in FIG. 9.

(a) A front substrate structure 11 and a back substrate structure 12 shown in FIG. 1 are prepared (hereinafter, called “substrate structure preparing step”).

The front substrate structure 11 is formed in advance in the following manner.

First, a front substrate 13 is prepared and X electrodes (first electrodes) 14 and Y electrodes (second electrodes) 15 configuring display electrode pairs are formed on one surface of the front substrate 13 in a predetermined pattern. At the electrode formation step, transparent electrodes (X transparent electrodes 14a, Y transparent electrodes 14b) and bus electrodes (X bus electrodes 14b, Y bus electrodes 15b) are formed in this order, using methods of photography and etching. Next, a dielectric layer 17 is formed on the front substrate 13 so as to cover the X electrodes 14 and the Y electrodes 15.

Next, a protective layer 18 shown in FIG. 1 is formed on a surface of the dielectric layer 17. The protective layer 18 is made from, for example, MgO and it can be formed by vacuum deposition method using MgO source as a target and utilizing electron beam.

When oxide metal such as MgO is used for the protective layer 18, the protective layer 18 has property that impurity such as moisture is adsorbed thereon easily. When the state that impurity such as moisture or carbon dioxide is adsorbed on the protective layer 18 is left for a long period of time, oxide metal such as MgO may react with moisture to deliquesce or to change in quality to hydroxide or carbonate such as Mg(OH)₂ or MgCO₃. The hydroxide or carbonate is considerably inferior to MgO which has not changed in quality regarding sputter resistance characteristic or the secondary electron emission coefficient. In order to prevent the protective layer 18 from changing in quality, it is preferable that the step of forming the protective layer 18 is performed just before an assembling step described later.

The back substrate structure 12 is formed in advance, for example, in the following manner.

First, a back substrate 19 is prepared and address electrodes 20 are formed on one surface thereof in a predetermined pattern. Next, a dielectric layer 21 is formed so as to cover the address electrodes 20 on the surface of the back substrate 19. Next, barrier ribs 22 for partitioning the discharge space are formed on a surface of the dielectric layer 21. The barrier ribs 22 are formed so as to extend along the address electrodes 20.

At the substrate structure preparing step, it is preferable that an air-flow hole 29 formed on at least one of the front substrate structure 11 and the back substrate structure 12 and an air-flow tube 30 connected to the air-flow hole 29 are formed in advance. As a method for forming the air-flow tube 30, a method for bonding an air-flow tube 30 formed in a cylindrical shape in advance using adhesive material (not shown) containing, for example, a low molting point glass as a main component may be adopted.

(b) Next, a sealing member 27 and supporting members 28 are formed on one of the front substrate structure 11 and the back substrate structure 12. FIG. 4 shows an example where the sealing member 27 and the supporting members 28 are formed on the back substrate structure 12.

First, sealing frit paste 27a which is material for the sealing member 27 (see FIG. 3) is applied to inside of an outer periphery of the back substrate structure 12. As the sealing frit paste 27a, paste obtained by dispersing inorganic particles containing, for example, low melting point glass frit as a main component into organic compound such as binder agent can be used. At this step, the sealing frit paste 27a is applied so as to surround the barrier rib formation region 26 in a frame shape. The sealing member 27 can be formed by continuous application of the sealing frit paste 27a with a width of several millimeters, for example, from a dispenser attached with a nozzle. The shape of the sealing frit paste 27a applied forms a quadrangle having four corner portions as shown as the supporting member 27 in FIG. 3.

Next, supporting member pastes 28a which are material for the supporting members 28 are applied between the barrier rib formation region 26 and the sealing frit paste 27a. As the supporting member paste 28b, paste obtained by dispersing inorganic particles containing, for example, glass frit as a main component into organic compound such as binder agent can be used.

However, since the supporting member 28 shown in FIG. 3 must be made from material having a softening point higher than that for the sealing member 27, adjustment must be performed such that inorganic particles contained in the sealing frit paste 27a are different in softening point from inorganic particles contained in the supporting member paste 28a (so that the softening point of the supporting member 28 is higher than that of the sealing member 27).

As a method for causing a difference in softening point, a method where leaded material containing lead (Pb) is used as the inorganic particles contained in the sealing frit paste 27a and non-leaded material which does not contain lead is used as the inorganic material contained in the supporting member paste 28a can be adopted, for example. When lead is contained even in the supporting member paste 28a, the softening point of the supporting member 28 can be raised by making a lead content rate of the supporting member paste 28a considerably lower than that of the sealing frit paste 27a.

When the non-leaded material (or material having a lead content rate lower than that of the sealing member 27) is used as material configuring the supporting member 28 and the leaded material (or material having a lead content rate higher than that of the supporting member 28) is used as material configuring the sealing member 27 in this manner, a difference in hue between the both occurs in addition to the difference in softening point. When hues of the supporting member 28 and the sealing member 27 are made different in this manner, management or identifications of panels or materials can be utilized in the manufacturing steps of PDP1.

When only non-leaded materials which do not contain lead (Pb) are used as inorganic particles contained in the sealing frit paste 27a and the supporting member paste 28a, the difference in softening point between the sealing frit paste 27a and the supporting member paste 28a is caused to occur by adjusting alkaline component lowering the softening point instead of lead. Here, adjustment of the alkaline component includes the following matter. The softening point is lowered by adding alkaline component such as sodium to glass material. The softening point lowers according to increase of the alkaline component content rate. Therefore, the content rate of the alkaline component contained in the supporting member 28 shown in FIG. 3 is made lower than that contained in the sealing member 27. Alternatively, such a configuration is adopted that alkaline component is contained in the sealing member 27 while alkaline component is not contained in the supporting member 28 can be adopted. Thereby, a difference in softening point between the sealing member 27 and the supporting member 28 can be caused to occur.

Alternatively, material different from that contained in the sealing member 27 (material having a softening point higher than that of the inorganic material used for the sealing frit paste 27a) may be used as the inorganic material contained in the supporting member 28 shown in FIG. 3. The supporting member 28 is not required to have a function of sealing a side of the PDP 1 (see FIG. 1), which is different from a function of the sealing member 27. Therefore, from materials having a softening point higher than that of the sealing member 27, a proper material can be selected considering adhesiveness with the back substrate 19 (or the front substrate 13) or forming property at an application time, so that options are increased.

As a method for applying the supporting member paste 28, a method for conducting application, for example, using a dispenser with a nozzle can be adopted like the case of the sealing frit paste 27a.

The supporting member 28 (see FIG. 3) has a function of supporting the front substrate structure 11 (see FIG. 2) during exhaust of gas in an internal space of the PDP 1 (see FIG. 1) when the front substrate structure 11 sinks down due to softening of the sealing member 27 (see FIG. 3) at the assembling step described later. In order to fulfill the function, it is necessary to secure a passage for exhausting gas in the internal space at the exhausting step described later. Therefore, when the supporting member paste 28a is applied, the supporting members 28 shown in FIG. 3 are formed at intervals by applying the supporting member paste 28a at a plurality of portions in spacing manner from each other, for example, as shown in FIG. 3.

FIG. 3 shows an example where supporting members 28 are formed on insides of four corner portions of the sealing member 27 forming a quadrangle so as to have an L shape with a bent portion. In this case, the supporting member paste 28a shown in FIG. 4 is applied along a plane shape of the supporting member 28 shown in FIG. 3.

In the present embodiment, formation is made such that a relationship among a height HR of the barrier rib 22 (a height from a surface of the back substrate 19 to a top portion of the barrier ribs 22), a height HS1 of the supporting member paste 28a (a height from the surface of the back substrate 19 to a top of the supporting member paste 28a), and a height HS2 of the sealing frit paste 27a (a height from the surface of the back substrate 19 to a top of the sealing frit paste 27a) satisfies the relationship as the height HR<the height HS1<the height HS2.

That is, formation is made such that, when the sealing member 27 and the supporting members 28 shown in FIG. 5 are formed by hardening the sealing frit paste 27a and the supporting member paste 28a, the height HS1 of the supporting member 28 is higher than the height HR of the barrier rib 22 and the height HS2 of the sealing member 27 is higher than the height HS1 of the supporting member 28.

By making the height HS1 of the supporting member 28 higher than the height HR of the barrier rib 22, exhaust clearance can be secured between the barrier rib 22 and the front substrate structure 11 (see FIG. 5) when gas in the internal space of the PDP 1 (see FIG. 1) is exhausted at the assembling step described later. By making formation such that the height HS2 of the sealing member 27 is higher than the height HS1 of the supporting member 28, the sealing member 27 can be securely fixed to the front substrate structure 11 and the back substrate structure 12 at the assembling step described later.

Incidentally, the order of the step of applying the sealing frit paste 27a and the step of applying the supporting member paste 28a can be determined properly.

Next, the sealing frit paste 27a and the supporting member paste 28a are heated (temporarily baked) to be hardened. At the temporarily baking step, since hardening is performed by evaporating the organic compound component in the pastes partially or wholly, temperature rising is performed up to a high temperature to some extent but the high temperature is lower than the softening point of the inorganic material contained in the sealing frit paste 27a.

The sealing member 27 and the supporting members 28 shown in FIG. 5 are obtained at a terminating time of the temporarily baking step. The sealing member 27 and the supporting members 28 shown in FIG. 5 maintain the relationship in height between the sealing frit paste 27a and the supporting member paste 28a at the application time thereof.

Accordingly, the formation is made such that the relationship among the height HR of the barrier rib 22 (a height from a surface of the back substrate 19 to a top portion of the barrier rib 22), the height HS1 of the supporting member 28 (a height from the surface of the back substrate 19 to a top portion of the supporting member 28), and the height HS2 of the sealing member 27 (a height from the surface of the back substrate 19 to a top portion of the sealing member 27) satisfies the relationship as the height HR<the height HS1<the height HS2.

Incidentally, in FIGS. 4 and 5, the method for forming the sealing member 27 and the supporting members 28 on the back substrate structure 12 has been explained, but the sealing member 27 and the supporting members 28 may be formed on the front substrate structure 11. In this case, the height HS1 of the supporting member 28 and the height HS2 of the sealing member 27 are heights from the surface of the front substrate 13 to the top portions of the supporting member 28 and the sealing member 27, respectively.

(c) Next, the front substrate structure 11 and the back substrate structure 12 are arranged to be opposed to each other and the PDP 1 is assembled. Assembling of the front substrate structure 11 and the back substrate structure 12 is performed in the following manner.

(c1) First, as an aligning step, alignment is performed in a state that a surface of the front substrate structure 11 on which the protective layer 18 has been formed and a surface of the back substrate structure 12 on which the barrier ribs 22 have been formed are opposed to each other, as shown in FIG. 5. At the aligning step, adjustment is performed such that the X electrode 14 (see FIG. 1) and the Y electrode 15 (see FIG. 1) on the front substrate structure 11 and the address electrode 20 on the back substrate structure 12 satisfy a predetermined positional relationship with each other.

In the present embodiment, at the aligning stage, only a top portion of the sealing member 27 abuts on the front substrate structure 11, and top portions of the supporting members 28 and top portions of the barrier ribs 22 do not abut on the front substrate structure 11.

When the aligning step is completed, the front substrate structure 11 and the back substrate structure 12 are clipped using a fixing jig such as, for example, a clip (not shown) to be fixed in order to prevent positional deviation which may occur thereafter.

(c2) Next, peripheral portions of the front substrate structure 11 and the back substrate structure 12 are sealed at a sealing and exhausting step. At the sealing and exhausting step, for example, the whole front substrate structure 11 and back substrate structure 12 aligned are heated along a temperature profile such as shown in FIG. 9 or FIG. 10 to soften the sealing member 27 and the supporting members 28 shown in FIG. 5 sequentially.

As heating means, for example, a method where the whole front substrate structure 11 and back substrate structure 12 aligned are placed within a heating furnace can be adopted as one example.

First, when the temperature of the sealing member 27 shown in FIG. 5 reaches the softening temperature, the sealing member 27 melts (softens) so that the front substrate 11 starts sinking down in a direction of the back substrate structure 12.

At this time, since the softening point of the supporting members 28 is higher than that of the sealing member 27, the supporting members 28 do not soften at this time, and since formation is made such that the height HS1 of the supporting members 28 is higher than the height HR of the barrier ribs 22, the sinking-down of the front substrate structure 11 stops when the front substrate structure 11 abuts on the top portions of the supporting members 28. That is, the front substrate structure 11 is put in a state that it is supported by the supporting members 28, as shown in FIG. 6.

Since melting adhesion to the front substrate structure 11 occurs due to softening of the sealing member 27, the peripheral portions on a region where the front substrate structure 11 and the back substrate structure 12 overlap with each other are sealed to each other. Accordingly, an air-flow passage between a space inside the region where sealing is performed by the sealing member 27 and a space outside the sealing member 27 is only an air-flow passage secured by the air-flow hole 29 and the air-flow tube 30 extending through the back substrate structure 12 shown in FIG. 6.

Incidentally, the dielectric layer 17 and the protective layer 18 are not formed to reach an end portion of the front substrate 13, as shown in FIG. 6. Therefore, the sealing member 27 adheres to the front substrate 13 in a melting manner. This is for preventing a leaking path other than the air-flow passage secured by the air-flow hole 29 and the air-flow tube 30 from occurring after sealing.

Next, as shown in FIG. 9 or FIG. 10, exhausting is started at a time when the temperature inside the heating furnace reaches the softening point of the sealing member 27. When exhausting is performed while heating is being conducted, impurity gas adsorbed on the front substrate structure 11 or the back substrate structure 12 leaves the protective layer 18, the phosphors 23, the barrier ribs 22, the supporting members 28 and/or the sealing member 27 to be discharged into a space inside the region sealed through the sealing member 27 and then exhausted outside the system via the air-flow hole 29 and the air-flow tube 30.

Incidentally, when a method for conducting heating while exhausting gas in the whole of the heating furnace is adopted as the heating means (for example, the vacuum heating furnace), for example, exhausting can be started just after heating is started. In this case, however, since gas in the whole heating furnace must be exhausted, a structure and/or a mechanism of a manufacturing apparatus become complicated. Since a volume of the region to be exhausted is large, large exhausting energy is required.

Accordingly, at the exhausting step, it is preferable that exhausting is started in a state that an air-flow pipe (not shown) is connected to the air-flow tube 30 shown in FIG. 6 after the sealing member 27 has been softened. In this case, for example, since exhausting can be performed by connecting the air-flow pipe to the air-flow tube 30, a structure and/or a mechanism of the heating furnace can be further simplified. Efficiency of exhausting energy can be achieved by making the volume of the region to be exhausted small as much as possible.

Now, according to the present embodiment, as shown in FIG. 6, exhausting can be performed in a state that the front substrate structure 11 is supported by the supporting members 28 having the height HS1 higher than the height HR of the barrier ribs 22.

Therefore, an exhausting clearance 31 can be secured between a surface (namely, a surface of the protective layer 18) of the front substrate structure 11 on the inner surface side and the top portions of the barrier ribs 22. By securing the exhausting clearance 31, an exhausting resistance can be largely reduced as compared with a case that exhausting is performed in a state that a surface of the front substrate structure 11 on the inner surface side and the top portions of the barrier ribs 22 abut on each other.

When the exhausting resistance is reduced, gas (gas containing impurity gas) in the space inside the region sealed by the sealing member 27 shown in FIG. 6 can be exhausted in a short time with small exhausting energy. That is, an impurity concentration in the discharge space 24 of the PDP 1 can be reduced efficiently.

Especially, in case of the above-mentioned PDP with the box structure (for example, the structure where the discharge space 24 is partitioned in box shapes by arranging the second barrier ribs extending along the row direction DX in addition to the first barrier ribs 22 extending in the column direction DY shown in FIG. 1), since the discharge space 24 is partitioned into box shapes, a clearance between the surface of the front substrate structure 11 on the inner surface side and the barrier ribs becomes considerably small when a structure where the supporting members 28 are not provided is adopted. Therefore, the PDP with the box structure tends to be larger in exhaust resistance than that of the PDP with the stripe structure.

However, according to the present embodiment, since the exhausting clearance 31 can be secured, the exhausting resistance can be considerably reduced even in application to the PDP with the box structure, so that the exhausting efficiency can be improved.

When the structure where the supporting members 28 are not provided is adopted, for example, one side of the sealing member 27 reaches the softening point before the other sides thereof reach the softening point due to variations of a temperature distribution in the heating furnace, so that the front substrate structure 11 may sink down disproportionately.

When the front substrate structure 11 sinks down disproportionately in this manner, variations occur in exhausting resistance of the space inside the region sealed by the sealing member 27 so that gas may stay partially.

However, according to the present embodiment, since exhausting can be performed in a state that the front substrate structure 11 is supported by the supporting members 28 whose temperatures do not reach the softening temperature, the exhausting resistance can be made even. Therefore, gas is preventing from staying and impurity gas can be exhausted outside the system reliably.

In the present embodiment, as described above, exhausting is performed in a state that the front substrate structure 11 is supported by the supporting members 28 having the height HS1 higher than the height HR of the barrier ribs 22 so that the exhausting efficiency is improved. Accordingly, such a structure must be adopted that the supporting members 28 do not cause positional deviation and the like and the front substrate structure 11 can be supported securely.

In order to support the front substrate structure 11 reliably, it is preferable that arrangement positions of the plurality of supporting members 28 are set to symmetrical positions regarding the center of a plane (a surface of the back substrate 19 in the case shown in FIG. 6) formed with the supporting members 28. By arranging the supporting members 28 at the symmetrical positions, the front substrate structure 11 can be supported in a balanced manner. When the supporting members 28 are arranged at the symmetrical positions, such a phenomenon that one side of the front substrate structure 11 sinks down prior to the other remaining sides thereof can be suppressed when the supporting members 28 soften and the front substrate structure 11 further sinks down.

It is preferable that the supporting members 28 are disposed along all sides of the quadrangle configuring the sealing member 28 shown in FIG. 3. This is because, by supporting the front substrate structure 11 at least four points, the front substrate structure 11 can be stabilized.

As shown in FIG. 3, it is preferable that the supporting members 28 are disposed inside four corner portions of the sealing member 27 configuring the quadrangle. This is because the largest area can be taken inside the supporting points supporting the front substrate structure 11.

Next, an especially desirable temperature profile when the exhausting efficiency in the state shown in FIG. 6 is managed will be explained. In the present embodiment, it is preferable that almost impurity gas in the space inside the region sealed by the sealing member 27 is exhausted in a state that the front substrate structure 11 shown in FIG. 6 is supported by the supporting members 28.

Therefore, in the temperature profile shown in FIG. 9, it is necessary to secure a time t1 from the softening point of the sealing member 27 to the softening point of the supporting members 28 reliably. If a temperature difference between the respective softening points of the sealing member 27 and the supporting members 28 can be taken large, as shown in FIG. 9, the time t1 can be secured even if heating is performed linearly from the heating start until the temperature exceeds the softening point of the supporting members 28.

However, the period of time required to exhaust impurity gas in the space inside the region sealed by the sealing member 27 shown in FIG. 6 varies according to the size or the structure of the PDP. Accordingly, in view of stable exhaust of impurity gas, it is desirable to control the time t1 from the softening point of the sealing member 27 to the softening point of the supporting members 28.

Therefore, as shown in FIG. 10, it is preferable that a temperature rising rate per unit time from the softening point of the sealing member 27 to the softening point of the supporting members 28 is made smaller than a temperature rising rate per unit time from the start of heating to the softening point of the sealing member 27. In this case, since the time t1 for exhausting in the state shown in FIG. 6 can be adjusted if necessary, almost impurity gas can be securely exhausted outside the system.

Next, when the temperature inside the heating furnace is further raised so that the temperature exceeds the softening point of the supporting members 28, the supporting members 28 soften. Thereby, the front substrate structure 11 further sinks down due to a self-weight of the front substrate structure 11 and a difference in air pressure between the internal space of the combined front substrate structure 11 and the back substrate structure 12 and the outside so that the front substrate structure 11 and a part of the top portions of the barrier ribs 22 partially abuts on each other.

The barrier ribs 22 are made from, for example, glass frit, and the softening point thereof is further higher than that of the supporting members 28. Therefore, the barrier ribs 22 are not softened so that sinking-down of the front substrate structure 11 is stopped when the front substrate structure 11 abuts on the top portions of the barrier ribs 22.

When exhausting is further conducted continuously in the state shown in FIG. 7, a vacuum degree in the space inside the region sealed by the sealing member 27 is further raised to reach approximately vacuum state. The front substrate structure 11 and the back substrate structure 12 are further firmly fixed by external atmospheric pressure.

Incidentally, in the present embodiment, as described above, almost impurity gas contained in the space inside the region sealed by the sealing member 27 can be exhausted outside the system in the state that the front substrate structure 11 has been supported by the supporting members 28. Accordingly, since a slight amount of gas adsorbed on the supporting members 28 and/or the sealing member 27 is exhausted outside the system when exhausting is performed in the state shown in FIG. 7, exhausting can be performed sufficiently even in the state that the front substrate structure 11 and the top portions of the barrier ribs 22 abut on each other.

(c3) Next, as a discharge gas filling step, exhausting is terminated at a time when the space inside the region sealed by the sealing member 27 reaches a predetermined vacuum degree, and discharge gas is then filled in the space. The discharge gas is introduced into the space from the air-flow passage secured by the air-flow tube 30 and the air-flow hole 29, as shown in FIG. 7.

Here, when the discharge gas is filled in the space, if impurity gas remains in the tube, the impurity gas may enter the space accompanied with the filling of the discharge gas. However, in the present embodiment, the air-flow hole 29 is disposed between the supporting member 28 and the sealing member 28, as shown in FIG. 3. Therefore, the discharge gas does not reach the barrier rib formation region 26 immediately, so that it reaches the barrier rib formation region 26 via the discharge gas introducing passage 32 restricted by the supporting member 28.

As shown in FIG. 7, for example, the protective layer 18 is formed inside the discharge gas introducing passage. The protective layer 18 has an easily adsorbing property of impurity gas. Therefore, even if impurity gas is introduced according to introduction of the discharge gas, it is adsorbed on the protective layer 18 formed in the gas introducing passage 32 or the like, so that the impurity gas is prevented from reaching the barrier rib formation region 26, which can result in prevention of lowering of display quality. Incidentally, such a configuration can be adopted that a getter agent is disposed in the gas introducing passage 32 so that adsorbing efficiency of the impurity gas is improved.

In the present embodiment, a bidirectional opening portion is provided between the supporting member 28 and the sealing member 27. Therefore, static pressure can be largely reduced as compared with a case that an opening portion allowing only one direction of air flow is provided. Therefore, the gas introducing passage 32 is formed, and the exhaust resistance can be prevented from increasing while the impurity gas is prevented from entering.

Finally, after the discharge gas is filled with a predetermined pressure, the air-flow tube 30 is sealed, as shown in FIG. 8, and an outer end portion of the air-flow passage is closed so that the PDP 1 shown in FIG. 1 is obtained.

As explained above, in the present embodiment, the supporting members 28 having a softening point higher than that of the sealing member 27 are formed between the barrier rib formation region 26 and the sealing member 27 shown in FIG. 3. Formation is made such that the height HS1 of the supporting members 28 is higher than the height HR of the barrier ribs 22 shown in FIG. 5 and the height HS2 of the sealing member 27 is higher than the height HS1 of the supporting members 28.

Thereby, since the exhausting clearance 31 can be secured between the barrier ribs 22 and the front substrate structure 11 at the exhausting step, the exhausting efficiency can be improved so that the impurity concentration in the discharge space can be reduced efficiently.

### Modified Example of the Present Embodiment

Now, a plan shape of the supporting member 28 and the plan position where the supporting member 28 is disposed are not limited to the structure shown in FIG. 3. Modified examples of the plan shape of the supporting member or the plan position where the supporting members are disposed will be explained below.

FIGS. 11 to 13 are plan views showing modified examples of a plan shape of the supporting members shown in FIG. 3 or a plan position where the supporting members are disposed. Incidentally, supporting members 35 and 36 shown in FIGS. 11 to 13, respectively, are similar to the supporting members 28 shown in FIG. 3 except for their plan shapes or plan positions where they are disposed. Accordingly, since material used for supporting members 35 and 36, heights of the supporting members 35 and 36 to be formed, or manufacturing method thereof are similar to those of the supporting members 28 shown in FIG. 3, repetitive explanations are omitted.

First, a difference between the supporting members 35 shown in FIG. 11 and the supporting members 28 shown in FIG. 3 lies in a plan shape. The supporting members 35 are formed along a straight line connecting two adjacent sides of four sides of the sealing member 27. Therefore, the supporting members 35 do not have bent portions and they are formed in an approximately linear shape, which are different from the supporting members 28 shown in FIG. 3.

When the supporting members 35 are formed in a straight line shape in this manner, they can be formed easily at a step of applying paste which is material for the supporting members 35.

The supporting members 35 are arranged inside four corner portions of the sealing member 27 at symmetrical positions regarding the center of a plane on which the supporting members 35 like the supporting members 28 shown in FIG. 3. Accordingly, when the front substrate structure 11 shown in FIG. 5 is supported by the supporting members 35 at the exhausting step, as described above, it is supported at four points, so that it can be supported stably.

In FIG. 11, both ends of the supporting members 35 do not contact with the sealing member 27, and a bidirectional opening portion is formed between the sealing member 27 and the supporting member 35. Therefore, static pressure can be reduced as compared with a case that an opening portion allowing only one direction air-flow is provided.

Incidentally, when one ends of the supporting members 35 shown in FIG. 11 are brought in contact with the sealing member 27, an opening portion is defined in one direction, so that static pressure at the exhausting step is increased as compared with the case that the opening portion is provided in two directions. However, according to the present embodiment, since exhausting can be performed in the state that the exhausting clearance shown in FIG. 5 is provided, the exhausting resistance can be largely reduced as compared with the case that the supporting members 35 are not formed. Accordingly, the structure where one end portions of the supporting members 35 are brought in contact with the sealing member 27 can be adopted.

In FIG. 11, the example where four supporting members 35 having an approximately same shape are arranged inside of four corner portions of the sealing member 27 is shown, but all the supporting members 35 are not required to have the same shape. For example, such a structure that the supporting member 28 shown in FIG. 3 is formed at a position nearest to the air-flow hole 29 while the supporting members 35 shown in FIG. 11 are formed at the remaining three portions can be adopted.

Even if the supporting members 28 and 35 different in plan shape are formed, the front substrate structure 11 (see FIG. 5) can be supported stably at the exhausting step by arranging the supporting members 28 and 35 at symmetrical positions regarding the center of the plane on which the supporting members 28 and 35 are formed.

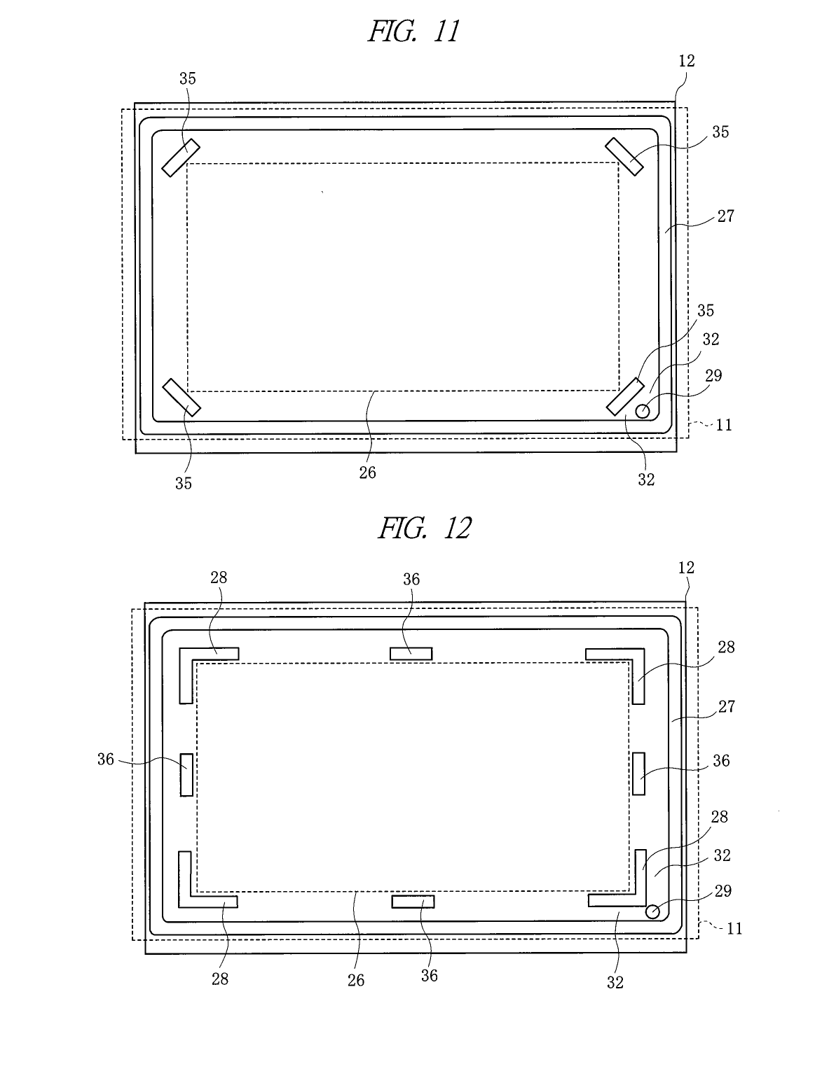

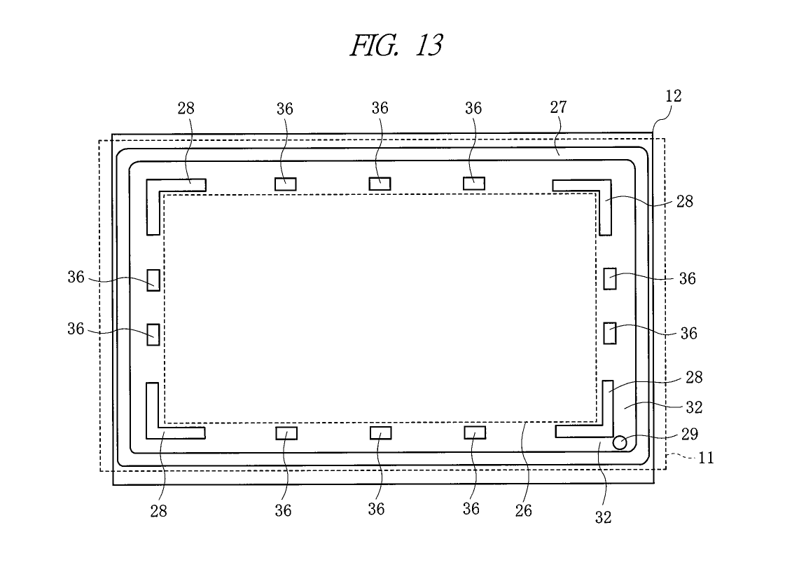

Next, as shown in FIG. 12, a second supporting member 36 can be formed between the adjacent supporting members (first supporting members) 28 in a spacing manner. As shown in FIG. 13, a plurality of second supporting members 36 may be disposed along one side of the sealing member 27 in a spacing manner, respectively

A plasma display apparatus incorporated with a PDP is caused to get bigger in recent years so that a plan size of the PDP tends to become large. The plan size of the front substrate structure (see FIG. 2) also becomes large according to enlargement of the plan size of the PDP 1 (see FIG. 2). Thus, even if the front substrate structure 11 is large, the exhausting clearance 31 shown in FIG. 5 can be secured at the above-mentioned exhausting step reliably by forming the second supporting members 36 in addition to the (first) supporting members 28 explained in FIG. 3.

Since the second supporting members 36 are arranged in a spacing manner from each other, respectively, the air-flow passage connected from the barrier rib formation region 26 shown in FIG. 13 to the air-flow hole 29 can be secured. Variations or differences in exhausting resistance can be reduced by adjusting sizes of the arrangement intervals of the second supporting members 36.

In the foregoing, the invention made by the inventors of the present invention has been concretely described based on the embodiments. However, it is needless to say that the present invention is not limited to the foregoing embodiments and various modifications and alterations can be made within the scope of the present invention.

For example, such a configuration can be adopted that the second supporting member(s) 36 shown in FIG. 12 or FIG. 13 are formed between the supporting members 35 shown in FIG. 11 and explained as the first modified example of the present embodiment.

For example, there are various PDPs having different structure corresponding to require performances or driving systems, where the present invention can be also applied to a PDP having a structure different from that in the PDP 1 explained in the above-mentioned embodiment.

For example, in the above-mentioned embodiment, a structure example where the address electrodes 20 are formed on the back substrate structure 12 has been explained as the example of the electrode structure of the PDP. However, a structure where the address electrodes 20 are provided on the front substrate structure 11 (for example, a structure where a second dielectric layer is laminated between the dielectric layer 17 and the protective layer 18 so that the address electrodes 20 are formed in the second dielectric layer) is also known, and such a structure can be applied with the present invention. The present invention can be applied to a structure having a similar planar positional relationship among the X electrodes 14, the Y electrodes 15, and the address electrodes 20.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A manufacturing method of a plasma display panel comprising:
(a) a step of preparing a first substrate structure which is formed with a plurality of first electrodes and a plurality of second electrodes configuring display electrode pairs and a dielectric layer covering the display electrode pairs on a first surface side of a first substrate and a second substrate structure which is formed with a barrier rib partitioning a discharge space on a second surface side of a second substrate;
(b) a step of forming, on one of the first substrate structure and the second substrate structure, a sealing member which is arranged in a frame shape so as to surround an outside of a barrier rib formation region on which the barrier rib is disposed and a plurality of supporting members which is disposed between an outer periphery of the barrier rib formation region and the sealing member so as to be spaced from one another; and
(c) a step of arranging the first substrate structure and the second substrate structure so as to be opposed to each other via the discharge space and assembling that, wherein
the step (c) includes
(c1) a step of arranging the first substrate structure and the second substrate structure so as to be opposed to each other via the discharge space, and
(c2) a step of bonding outer peripheries of the first substrate structure and the second substrate structure on a region where the first substrate structure and the second substrate structure overlap with each other in the sealing manner by heating the sealing member and exhausting gas in a space inside a region formed with the sealing member via an air-flow passage formed between the supporting member and the sealing member,
the supporting members are made from material having a softening point higher than that of material for the sealing member, and
at the step (b), the formation is made such that the height of the supporting members is higher than the height of the barrier rib and the height of the sealing member is higher than the height of the supporting members.

2. The manufacturing method of a plasma display panel according to claim 1, wherein
the supporting member are arranged at symmetrical positions regarding the center of a plane on which the supporting members are formed.

3. The manufacturing method of a plasma display panel according to claim 2, wherein
the sealing member is arranged along an outer periphery of the region where the first substrate structure and the second substrate structure overlap with each other so as to form a quadrangle, and the supporting members are arranged inside of four corner portions of the quadrangular sealing member.

4. The manufacturing method of a plasma display panel according to claim 3, wherein
the supporting members includes first supporting members arranged inside the four corner portions of the sealing member and a second supporting member arranged between adjacent ones of the first supporting members in a spacing manner.

5. The manufacturing method of a plasma display panel according to claim 3, wherein
the supporting members are formed along respective straight lines connecting two adjacent sides of the four sides of the sealing member, and clearances are formed between both ends of the supporting members and the sealing member.

6. The manufacturing method of a plasma display panel according to claim 3, wherein
a bidirectional opening portion is provided between a supporting member of the plurality of supporting members arranged at a position nearest the air-flow passage and the sealing member.

7. The manufacturing method of a plasma display panel according to claim 1, wherein
the step (c2) includes a step of heating whole of the first substrate structure and second substrate structure arranged so as to be opposed to each other, and a temperature profile at the heating step is set such that a temperature rising rate per unit time from a softening point of the sealing member to a softening point of the supporting members is made smaller than a temperature rising rate per unit time from a start of heating to the softening point of the sealing member.

8. The manufacturing method of a plasma display panel according to claim 1, wherein
the supporting members and the sealing member are different in hue.

9. A plasma display panel comprising:
a first substrate structure and a second substrate structure arranged so as to be opposed to each other via a discharge space;
a barrier rib arranged so as to partition the discharge space on an opposing surface side of the first substrate structure and the second substrate structure;
a frame-shaped sealing member disposed so as to surround an outside of a barrier rib formation region on which the barrier rib is disposed and a sealing member of a frame shape which seals a space between the first substrate structure and the second substrate structure;
a plurality of supporting members disposed in a region between an outer periphery of the barrier rib formation region and the sealing member so as to be spaced from one another; and
an air-flow passage arranged between the supporting member and the sealing member, an outer end of the air-flow passage being sealed, wherein
the supporting members is made from material having a softening point higher than that of material for the sealing member.

10. The plasma display panel according to claim 9, wherein
the sealing member is arranged along an outer periphery of the region where the first substrate structure and the second substrate structure overlap with each other so at to form a quadrangle, and the supporting members are arranged inside of four corner portions of the quadrangular sealing member.
